(19) United States
(12) Patent Application Publication
(10) Pub. No.: US 2007/0013990 A1
(43) Pub. Date: Jan. 18, 2007

(54) Miniature motor for optical device based on electrowetting

(75) Inventors: Bernardus Hendrikus Wilhelmu Hendriks, Eindhoven (NL); Stein Kuiper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/554,225

(22) PCT Filed: Apr. 27, 2004
(86) PCT No.: PCT/IB04/50517

§ 371 Date: Oct. 25, 2005

(30) Foreign Application Priority Data
Apr. 29, 2003 (EP) 03101174.5

(51) Int. Cl. G02B 26/02; G02B 5/00

(52) U.S. Cl. 359/228; 359/227; 359/230; 359/234

(57) ABSTRACT

Motor, comprising a first body (3) and second body (5), the latter being movably mounted with respect to the first body. A chamber (4), sandwiched between surfaces of said bodies, is filled with a non-polar and/or non-conductive first fluid (6) and at least one volume of a polar and/or conductive second fluid (7), which fluids are immiscible. One of said surfaces is provided with means (10) for locally varying the wettability of said surface by the second fluid, to move the or each volume of second fluid along a desired path. The other surface is provided with means (9, 14, 15) for coupling the or each volume of second fluid to this surface, so that this surface will be dragged along by the moving volume or volumes. This results in a relative movement between both surfaces and hence in a movement of the second body.

The invention relates to a motor, in particular a miniature motor, for rotation of for instance a mirror in an optical microswitch or a focusing or zoom system in for instance cameras or scanners.

Ongoing miniaturization of these and similar appliances has raised a need for ever smaller motors. This need is presently met by downsizing existing ‘normal size’ motors. However, as a rule of thumb the costs of manufacture rise as the size of the motor decreases, which rise is often disproportional. Moreover, some types of motors cannot easily be miniaturized or only up to a certain extent. For instance, miniaturization of electromotors based on coils and magnets is limited to the point where the coils can no longer be wound. Other motors, for instance those based on piezoelectric principles, can be miniaturized but are relatively expensive to manufacture.

It is an object of the invention to provide a motor, which can be miniaturized and manufactured in a cost effective way.

This object is achieved by the motor according to the invention, which comprises a first body, a second body movably mounted with respect to the first body, a chamber situated between a surface of the first body and a surface of the second body, said chamber being filled with a non-polar and/or non-conductive first fluid and at least one volume of a polar and/or conductive second fluid, the fluids being immiscible, wherein one of said surfaces, to be called the first surface, is provided with means for locally varying the wettability of said surface by the second fluid and the other surface, to be called the second surface, is provided with means for coupling the or each volume of second fluid to the second surface.

The motor according to the invention makes advantageously use of known wetting techniques for manipulating a volume of a fluid along a predetermined path. With these techniques, the surface tension of said volume is locally reduced, electrically, thermally or chemically, causing the volume to flow in the direction of its lowest surface tension. This movement is subsequently conveyed to a movably mounted body by coupling the volume of fluid to said body by suitable coupling means. In this way, the body will be dragged along by the moving volume. In more general wording: by using known wetting techniques to manipulate a volume, e.g. a droplet of fluid along a first surface and having this volume adhere to a second surface, one of these surfaces (belonging to the movably mounted body) can be moved relative to the other surface (belonging to the static body).

In a first preferred embodiment according to the features of claim 2, the coupling between said volume of fluid and said second surface is achieved through wetting forces, induced by providing the second surface with at least one permanent or temporary area of high wettability by said fluid.

In a second preferred embodiment according to the features of claim 3, the coupling is achieved through surface tension forces. To that end, the second surface is provided with at least one recess, filled with said fluid. The volume may be coupled to this fluid through surface tension forces, whereas the fluid may be anchored in the recess through suitable recess design.

A combination of the two coupling principles is possible as well. For both embodiments, the external forces to overcome to move the movable body should not exceed the surface tension forces of the volume, because this would cause the volume to split up and remove the coupling.

A motor based on the above described principles offers the advantage that it can be relatively easily miniaturized and manufactured cost effectively, thanks to the absence of complicated components. In fact, the most critical aspects of the motor will be the dimensions of the chamber between the first and second body and the positioning of the means for varying the wettability, which determine the path of the droplets and consequently the movement of the motor. The chamber is preferably of capillary dimensions. For most fluids this means dimensions of the order of several millimeters at most. With present day manufacturing techniques such dimensions and any tolerances associated therewith can be easily accomplished. A motor according to the invention furthermore offers reliable, smooth and wear-free operation thanks to the absence of dry friction. Also, in respect of the dimensions of the motor, relatively large displacements are possible.

According to a preferred embodiment, a motor according to the invention is characterized by the features of claim 4.

The use of electrodes to vary the wettability of the first surface (and possibly that of the second surface in case of the first preferred embodiment), offers the advantage that electrodes can be easily driven, in any desired sequence, with relatively low voltages. Power consumption can be low, resulting in an energy effective motor. Further, the electrodes can be easily manufactured, at relatively low cost and in relatively small sizes, for instance by known etching techniques. Also, the electrodes offer great freedom in possible motor movement, because the electrodes can be positioned in any desired pattern and activated in any desired order to force a volume of fluid along a desired path. Since the movement of the movable body will largely correspond to the path of movement of said volume of fluid, it will be clear that complex motor movements can be accomplished just by proper arrangement and activation of the electrodes. Furthermore, the electrodes keep the volume in place, as a consequence of which no fixed (physical) channels are needed. This contributes to the simplicity of the motor configuration.

In a further preferred embodiment, a motor according to the present invention is characterized by the features of claim 7.

The use of a liquid metal as second fluid, for instance mercury, offers the advantage that such fluids usually have a very high surface tension, which prevents the volumes from premature splitting up. This of course is especially advantageous when the external forces on the body to be moved are expected to be relatively large.

In an alternative preferred embodiment, a motor according to the present invention is characterized by the features of claim 10.

The use of an aqueous solution as a second fluid offers the advantage that the wetting force of such solutions is very high on some materials (e.g. glass) and their surface tension is relatively high as well. Furthermore, aqueous solutions, thanks to their non-abrasive nature impose little restrictions on the other materials to be used, are easy to handle and in general quite harmless, so that no demanding protective provisions are needed with regard to leakage. Moreover, droplets of an aqueous solution can be displaced with relatively low voltages and relatively low power consumption.

If the second fluid is an aqueous solution, the first surface is preferably covered with a layer of hydrophobic material which can be locally changed to hydrophilic with suitably arranged electrodes. The second surface is preferably covered with alternating layers of hydrophilic and hydrophobic material, to form areas of high and low wettability respectively. Such layers of hydrophobic and hydrophilic material can be easily applied with known coating techniques, for instance by means of lithography. This technique also offers the possibility of applying a pattern of hydrophilic material onto an otherwise hydrophobic surface, so as to form paths or channels for the volumes of second fluid.

It will be clear to the skilled person that the number of volumes of second fluid, or the volume itself can be increased to increase the attainable wetting force. It will furthermore be clear that the afore-described motor principle can be used to construct both rotary and linear motors, by a proper design of the first and second bodies as well as an appropriate design of the movement paths for the or each volume of second fluid. Also, it will be clear that either the movable body or the static body can be provided with the means for varying the wettability. However, due to the wiring needed, mounting the means on the static body will usually be most convenient. Of course it is also possible to provide both bodies with means for varying the wettability. This will make the surfaces functionally interchangeable and hence adaptable to any given situation. In that case, it is also possible to activate the wetting means on both surfaces simultaneously but at a different pace, which will result in a sort of artificial skid. This may for instance be used for actively controlled deceleration of the movable body.

The invention furthermore relates to an optical device, comprising the motor according to the invention, for instance for driving a reflective element.

Further advantageous embodiments of a motor according to the present invention are set forth in the dependent claims.

To explain the invention, exemplary embodiments thereof are hereinafter described with reference to the accompanying drawings, wherein:

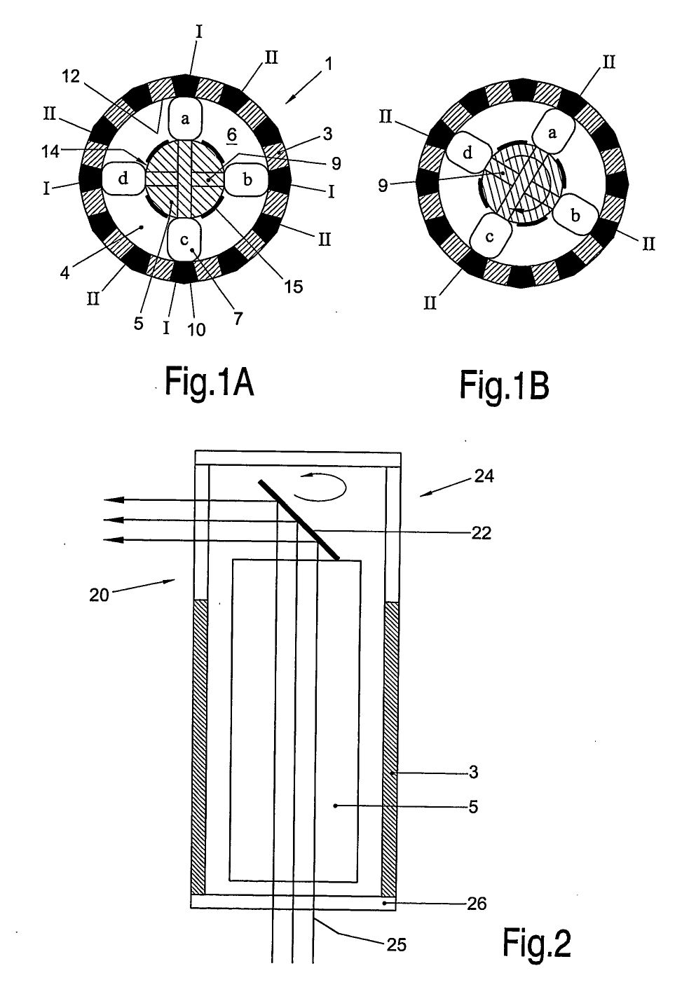

FIGS. 1A,B show in transverse cross section a rotary motor according to a first embodiment of the present invention, in two successive positions;

FIG. 2 shows schematically, in longitudinal cross section a possible application of the rotary motor according to FIG. 1 in an optical scanner; and

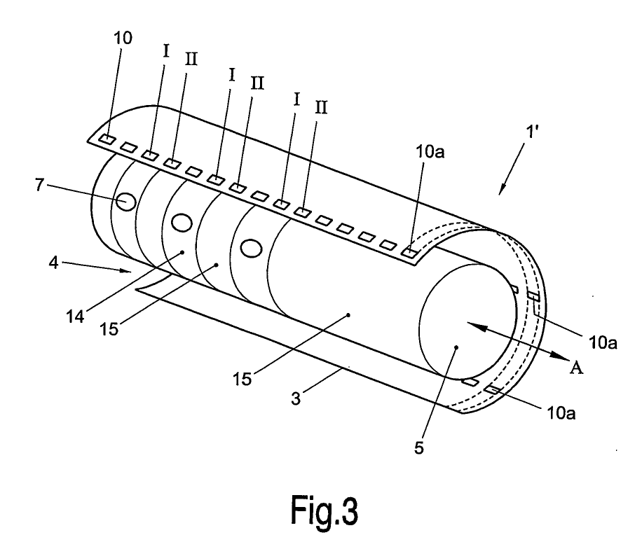

FIG. 3 shows schematically a linear motor according to a further embodiment of the invention.

In this description, identical or corresponding parts have identical or corresponding reference numerals. All combinations of parts of the embodiments shown and described are explicitly understood to be incorporated in this description.

In this description, the term ‘wetting’ is understood to encompass all techniques causing the surface tension of a volume, e.g. a droplet of a specific fluid to be locally varied, so as to influence the wetting behavior of said fluid with respect to a specific surface. When this influencing is done electrically (as opposed to for instance thermally or chemically) the term ‘electrowetting’ will be used. More particularly, the term electrowetting is understood to at least encompass the process whereby an electric potential is applied across an interfacial layer between a droplet and an electrode, causing the wetting behavior of the droplet to alter, in particular to improve. The term ‘wettability of a surface by a certain fluid’ is understood to give an indication of the ease with which said fluid may wet said specific surface, which may for instance depend on the nature of and/or the electric potential across said surface. If a surface has a ‘high wettability by a specific fluid’, this indicates that a droplet of said fluid in contact with said surface will have a rather expanded shape, with a relatively large contact area and a relatively small contact angle, usually less than about 90°, whereas ‘low wettability’ indicates that the droplet in contact with said surface will have a rather contracted shape, with a relatively small contact area and a relatively large contact angle, usually exceeding about 90°. If the specific fluid is an aqueous solution, the term high wettability will be replaced by hydrophilic and the term low wettability will be replaced by hydrophobic.

FIG. 1A,B shows a first embodiment of a motor 1 according to the present invention, in particular a rotary motor, comprising a substantially cylindrical first body 3 and a substantially cylindrical second body 5, which is concentrically positioned within the first body 3. The first and second body 3, 5 enclose between their respective inner and outer surfaces a substantially cylindrical chamber 4, which is filled with a non-polar and/or non conductive first fluid 6, for instance air or an oil, and volumes 7a-d of a polar and/or conductive second fluid 7, in this example an aqueous solution, for instance (salted) water. Both fluids 6, 7 are immiscible.

The first body 3 is provided with means for varying the wettability of its inner surface, namely twelve electrodes 10 extending in axial direction of the first body 3, spaced at substantially regular radial intervals along the circumference. The inner surface of the first body 3 is covered with a layer 12 of electrically insulating, hydrophobic material or more generally: a material having a wettability by the second fluid 7 which is lower than the wettability by the first fluid 6. Examples of such material are for instance Teflon-like materials like the amorphous fluoropolymer AF1600 provided by Dupont or parylene or a combination thereof, in case where the first fluid 6 is an oil or air and the second fluid is (salted) water. Alternatively, the first body 3 can be made of said hydrophobic material, and the electrodes 10 may be embedded in the first body 3, just below its inner surface, so that they are covered by a thin layer 12 of said hydrophobic material. The electrodes 10 are connected to a voltage supply (not shown).

The second body 5 is of solid design but could be hollow, if so desired, and is mounted movably, in particular rotatably, in the first body 3 by one or more suitable bearings. The or each bearing could for instance be an oil bearing, configured by providing the first and/or second body 3, 5 with an annular groove, in which upon rotation of the second body 5, pressure will build up, centering the second body 5 in the first body 3.

The second body 5 is provided at its outer surface with coupling means in the form of four hydrophilic areas 14, said number corresponding to the number of volumes 7a-d. These areas 14 could for instance be made of or covered by a material having a wettability by the second fluid 7 that is higher than the wettability by the first fluid 6. In the present example, given the selected first and second fluids 6, 7, this material could for instance be glass. The areas 14 are separated from each other in radial direction by areas 15, made of or covered by hydrophobic material, which could be a selection from any one of the materials mentioned before. Additionally or alternatively, the hydrophilic areas 14 may be recessed to enhance the coupling force with the volumes. Furthermore, two or more of the volumes 7a-d could be interconnected via at least one suitable conduit 9 in second body 5, as illustrated in broken lines in FIGS. 1A,B. Such conduit 9 can be easily manufactured. The areas of high and low wettability 14, 15 may be omitted, but can also be maintained, to increase the maximum force the motor may exert.

A motor as described above operates as follows. In FIG. 1A the electrodes 10 marked with Roman numerals I (that is the upper, lower, left and right electrodes) are supplied with a voltage. Consequently, the hydrophobic layer 12 covering said electrodes I will become locally hydrophilic. The four volumes 7a-d will therefore contact the first body 3 at the four electrodes I. They furthermore contact the second body 5 at the coupling means, that is the hydrophilic areas 14 and the conduits 9. If, subsequently, the voltage supply is shifted to second electrodes II, situated next to the former electrodes I, the layer above said second electrodes II will become hydrophilic, whereas the layer above the first electrodes I will switch back to hydrophobic. This gives rise to electrowetting forces which draw the volumes 7a-d towards the hydrophilic areas II as shown in FIG. 1B. During this movement the volumes 7a-d will move along the hydrophilic area 14 of the second body 5 up to the edge of the hydrophobic area 15. Further movement along the second body 5 will be blocked by the combined action of the hydrophobic area 15 and the first fluid 6, enabling the volumes 7a-d to exert a wetting force on the second body 5, which will cause the body 5 to rotate. Hence by sequentially activating successive electrodes 10 I, II with a suitable voltage, the second body 5 can be rotated continuously. Preferably, the electrodes 10 are positioned relatively close to each other or even overlap through a ‘tooth’ structure. Also, the radial dimensions of the electrodes 10 are preferably equal to or smaller than the radial dimensions of the volumes 7a-d. Such positioning and/or dimensioning of the electrodes 10 will ensure that the volumes 7a-d can ‘sense’ a newly supplied voltage to a succeeding electrode 10 II.

In the given example the rotation is clockwise. It will be appreciated that this direction can be readily reversed by reversing the order in which the electrodes 10 I, II are activated. Obviously, the frequency of rotation will depend on the activation frequency of successive electrodes 10 I, II. It is noted that although in the illustrated example four volumes 7a-d of conductive fluid are used, this number could be any number. The volumes 7a-d may be line-shaped in axial direction or consist of a series of axially spaced droplets. It is further noted that with the embodiment of FIG. 1, it is also possible to have the first body 3 rotate instead of the second body 5, provided the first body 3 is rotatably mounted and the second body 5 is fixed. In that case, upon switching the voltage from the first I to the second electrodes II, the volumes 7a-d would move towards this second electrode II (featuring the higher wettability) as far as the edge of the hydrophilic area 14. Subsequently, the second electrodes II due to wetting forces would be drawn to the volumes 7a-d, causing the first body 3 to rotate anti-clockwise. From this discussion it is also immediately clear that for the operation of the motor I it is irrelevant whether the electrodes 10 are positioned on the static body or the movable body. Therefore, although in practice the electrodes 10 will usually be placed on the static body to avoid wiring problems, the presented embodiment should in no way be seen as limiting.

A motor as described above offers several advantages. For instance, the motor can be manufactured cost-effectively, since all layers 12, 14, 15 can be applied by relatively simple, known coating techniques, such as lithography. Furthermore, all parts of the motor have a relatively simple configuration and are therefore suitable for far-reaching miniaturization. Also, the volumes 7a-d do not require fixed, that is physically restricted, channels. A suitable layout of hydrophobic and hydrophilic layers will suffice to keep the volumes in place. This adds to the simplicity of manufacture, as such layout of hydrophobic and hydrophilic layers can be easily applied by known aforementioned coating techniques. Furthermore, the motor can be very easily adjusted to perform a great number of different motor movements, as will be explained in further detail below.

The embodiment shown in FIG. 1 can be easily converted into a linear motor 1′, by rotating the orientation of the electrodes 10 over 90°, that is from a radial towards an axial orientation as shown in FIG. 3, in which part of the first body 3 is left out, for clarity's sake. Instead of the separate series of axially orientated electrodes 10, ring-shaped electrodes could be applied, as indicated in broken lines for the first electrode 10A of the series. Furthermore, the alternating areas of high and low wettability 14, 15 have been converted into ring shaped areas, alternating in the axial direction of the second body 5. Volumes of second fluid 7 are in contact with a ring 14 of high wettability and an activated electrode I at the first body 3. Upon activation of the next electrodes II, the volumes 7 will move in axial direction along the inner surface of the first body 3, dragging the second body 5 along in the axial direction A, thanks to the blocking action of the ring-shaped areas 15 of low wettability (or coupling forces provided by recesses or conduits, not shown). Stop mechanisms can be provided to limit the maximum stroke of the second body 5. The volumes 7 of second fluid may be shaped as droplets, spaced at regular intervals along the ring 14, as illustrated. However, the volumes 7 can also be ring-shaped, so as to cover the ring-shaped area 14, resulting in an evenly and symmetrically distributed wetting force along the circumference of the second body 5. The number of volumes 7 and ring-shaped areas 14 in axial direction can also be any desired number.

From the above-described embodiments it will be appreciated, that by rearranging the position of the electrodes 10 along the circumference of the first body 3 and accordingly adapting the coupling means on the second body 5, the motor 1,1′ can be simply adjusted to perform a wide variety of movements. For instance, the features of the motors 1, 1′ according to FIGS. 1 and 3 can be combined so as to create a motor having a movable body 5 that can rotate and translate, either sequentially or simultaneously, the latter resulting in a spiral-like movement. Moreover, if the electrodes 10 on the first surface are arranged in a grid and the coupling means 9, 14 on the second surface are configured as spots, each accommodated to couple a volume 7 of second fluid, it becomes possible to drive the movable body 5 in any desired direction. Freedom of movement can even further be increased by providing the second surface too with a grid of electrodes, similar to the ones of the first surface, with which hydrophilic areas 14 can be created according to ones' needs. Hence, a motor 1, 1′ according to the invention offers great flexibility in attainable motor movements, with a standard set of simple components.

FIG. 2 shows one possible application of a motor 1 according to FIG. 1, in an optical scanner 20. In this embodiment the cylindrical first body 3 is near its ends 24, 26 made of transparent material. The second body 5 is made of transparent material as well, for instance glass, and rotatably mounted in the first body 3, for instance by means of one or more oil bearings as described previously. A mirror 22 is mounted on top of the second body 5, including an angle of about 45° to the longitudinal axis thereof. A light beam, entering the second body 3 through its lower transparent portion 26, will reach the mirror 22 through the transparent second body 5, be deflected over 90° and exit the first body 3 through its upper transparent portion 24. Rotation of the second body 5 will result in a rotating spot. Such a scanner can for instance be used in a catheter to scan inside surfaces of blood vessels.

The invention is not in any way limited to the exemplary embodiments shown in the description and the figures. Many variations thereof are possible within the scope of the invention.

For instance, the first and second body do not need to be cylindrical. These bodies can have any shape, as long as they are each provided with a surface, which can cooperate with the surface of the other body so as to form a chamber, in which volumes of a second fluid can contact both surfaces. For instance, one of the bodies could have a cup-shaped surface whereas the other body could have a ball-shaped surface so as to form a cup-and-ball joint. The semi-spherical chamber enclosed between said bodies could be filled with oil and droplets of water, which could be driven according to above-described motor principle, to have one of the bodies rotate in any desirable direction. Also, the number and shape of the volumes of second fluid is not limited to the ones shown in the embodiments. More or fewer volumes are feasible, having any desirable shape. Furthermore, the first and second fluid can be of a different material. The second fluid may for instance be a liquid metal, such as mercury, whereas the first fluid may be an electrolyte, immiscible with mercury. In that case, each volume may be positioned between a pair of electrodes, with which an electrical field can be applied over the volume, extending in the direction of intended movement of the volume. This field will cause the volume to move towards one of the electrodes. This movement can be prolonged into a continuous movement, by making use of overlapping electrode pairs, activated sequentially. The moving volume can be coupled to the movable body in the same way as described above for dragging this body along, that is through wetting forces induced by appropriate alternating areas of high and low wettability and/or by interconnection of these volumes via conduits in the second body.

These and many comparable variations are understood to fall within the scope of the invention as set out in the appended claims.

1. A motor, comprising a first body (3), a second body (5) movably mounted with respect to the first body (3), a chamber (4) situated between a surface of the first body (3) and a surface of the second body (5), said chamber (4) being filled with a non-polar and/or non-conductive first fluid (6) and at least one volume of a polar and/or conductive second fluid (7a-d), the fluids (6, 7) being immiscible, wherein one of said surfaces, to be called the first surface, is provided with means for locally varying the wettability of said surface by the second fluid (7) and the other surface, to be called the second surface, is provided with means for coupling the or each volume of second fluid (7a-d) to the second surface.

2. A motor according to claim 1, wherein the coupling means comprise at least one area (14) of high wettability by the second fluid (7), said area being bounded by an area (15) of low wettability by said second fluid (7), at least in a direction of relative movement of said first and second surface.

3. A motor according to claim 1, wherein the coupling means comprise at least one recess (9), which opens into the chamber (4) and is filled with the second fluid (7), so that the at least one volume of second fluid (7a-d) in the chamber (4) will be coupled to the second fluid (7) in the recess (9) through surface tension forces.

4. A motor according to claim 1, wherein the means for locally varying the wettability of the first surface and/or the second surface, comprise a series of neighboring electrodes (10), separated from the second fluid (7) by an interfacial layer (12), and means for sequentially powering successive electrodes (10) so as to apply an electric potential across said interfacial layer (12), causing the condition thereof to switch between low and high wettability by the second fluid (7).

5. A motor according to claim 4, wherein the electrodes (10) are spaced at substantially regular intervals along an intended path of movement of the or each volume (7a-d) of second fluid.

6. A motor according to claim 1, wherein the second fluid (7) is a liquid.

7. A motor according to claim 6, wherein the second fluid (7) is a liquid metal.

8. A motor according to claim 7, wherein the first fluid (6) is an electrolyte.

9. A motor according to claim 8, wherein the first fluid (6) forms the interfacial layer.

10. A motor according to claim 6, wherein the second fluid (7) is an aqueous solution, for instance water, more particularly salted water.

11. A motor according to claim 10, wherein the interfacial layer (12) is a dielectric layer having a low wettability by the second fluid (7).

12. A motor according to claim 11, wherein the dielectric layer (12) is made of hydrophobic insulating material.

13. A motor according to claim 12, wherein the hydrophobic insulating material is AF1600 and/or parylene.

14. A motor according to claim 10, wherein the first fluid (6) is a gas, for instance air, or a liquid, for instance oil.

15. A motor according to claim 10, wherein the second surface is covered by or made of hydrophobic material and provided with at least one area (14) of hydrophilic material, to form an area having a low wettability by the second fluid (7).

16. A motor according to claim 1, wherein the first and the second body (3, 5) are both substantially cylindrical, wherein one of the bodies (3; 5) is concentrically received within the other body (5; 3) and the chamber (4) is enclosed between the inner surface of the outer body and the outer surface of the inner body.

17. A motor according to claim 1, wherein the motor is a rotary motor (1), wherein the second body (5) is arranged for rotating movement with respect to the first body (3).

18. A motor according to claim 1, wherein the motor is a linear motor (1′), wherein the second body (5) is arranged for translating movement with respect to the first body (3).

19. A motor according to claim 16, wherein the electrodes (10) are spaced at regular radial intervals along the circumference of one of the bodies (3, 5).

20. A motor according to claim 16, wherein the inner body (3; 5) is the second, moveable body (5).

21. A motor according to claim 1, wherein the first surface belongs to the first body (3) and the second surface belongs to the second, moveable body (5).

22. A motor according to claim 1, wherein the chamber (4) between the first and second body (3, 5) is of capillary dimensions.

23. A motor according to claim 1, wherein the chamber (4) comprises channels for the second fluid (7), said channels being formed by covering the second surface with or making the second surface of a material with low wettability by the second fluid (7) and providing the surface with a channel-constituting pattern of material with high wettability by the second fluid.

24. Optical device, comprising a reflective element and a motor according to claim 1, for moving said reflective element.
